(19) United States
(12) Patent Application Publication
(10) Pub. No.: US 2004/0104212 A1
(43) Pub. Date: Jun. 3, 2004

(54) Ceramic cooktop

(76) Inventors: Rainer Gadow, Aschau am Inn (DE); Andreas Killinger, Filderstadt-Bernhausen (DE); Christian Friedrich, Muenchen (DE); Chuanfei Li, Stuttgart (DE); Karsten Wermbter, Budenheim (DE)

Correspondence Address: HARNESS, DICKEY & PIERCE, P.L.C., P.O. BOX 828, BLOOMFIELD HILLS, MI, 48303, US

(21) Appl. No.: 10/647,806

(22) Filed: Aug. 25, 2003

Related U.S. Application Data
(63) Continuation of application No. PCT/EP02/01751, filed on Feb. 20, 2002.

(30) Foreign Application Priority Data
Mar. 6, 2001 (DE) 101 12 235.7

(51) Int. Cl. H05B 3/68

(52) U.S. Cl. 219/465.1

(57) ABSTRACT

The invention relates to a ceramic cooktop comprising a cooking plate (12) made of glass ceramic or glass. The ceramic cooktop also comprises an electrical heat conductor layer (18), an insulating layer (16) that is located between the cooking plate (12) and the heat conductor layer (18), and an electrically conductive intermediate layer (14) between the cooking plate (12) and the insulating layer (16). The intermediate layer (14) is a thermally sprayed layer consisting of an electrically conductive ceramic material, preferably of an oxide layer that is rendered electrically conductive by oxygen loss occurring during thermal spraying, or of a cermet.

### RELATED APPLICATIONS

This is a continuation application of copending International patent application PCT/EP02/01751, filed on Feb. 20, 2002 and designating the United States which was not published in English under PCT Article 21(2), and claiming priority of German patent application DE 101 12 235.7 filed on Mar. 06, 2001. Additional copending applications are PCT/EP02/01743 and PCT/EP02/01742.

### BACKGROUND OF THE INVENTION

The invention relates to a ceramic cooktop comprising a cooking plate of glass ceramic or glass, an electric heat conductor layer, an insulating layer between the cooking plate and the heat conductor layer, and an electrically conducting intermediate layer between the cooking plate and the insulating layer. The invention further relates to a method of producing such a ceramic cooktop.

Such a ceramic cooktop is known from DE 31 05 065 C2 and from U.S. Pat. No. 6,037,572.

The cooking plate according to DE 31 05 065 C2 consists of a glass ceramic at the bottom side of which a metallic layer is applied, e.g. by a spraying operation, onto which another ceramic insulating layer is applied also by a spraying operation, onto which finally a heat conductor element is evaporated or applied by a spraying operation.

It is known that glass ceramics which are utilized for cooktops have a NTC-characteristic, i.e. with rising temperature also the electric conductivity raises considerably. To avoid a current flow between a metallic pot or the surface of the cooking plate, respectively, and the heat conductor, therefore, an electric insulating layer is mandatory for operating such a cooking system. To guarantee the necessary safety requirements, the system must have an electric breakdown resistance of 3,750 Volts.

Since such ceramic cooktops must be designed for operating temperatures of up to about 600° C., major problems may result due to the differences between the coefficients of thermal expansion of the materials applied. While the coefficient of thermal expansion for a glass ceramic, such as a glass ceramic of the trademark Ceran® of Schott is in the range of ±0.15×10⁻⁶ K⁻¹, the coefficients of thermal expansion of ceramic materials are considerably higher. Thus for instance the coefficient of thermal expansion for Al₂O₃ is about 8×10⁻⁶ K⁻¹. By contrast, the coefficients of thermal expansion of metals are considerably higher.

Inter alia thermal spraying has become known as an application process for the individual layers, since thereby various materials can be applied in a relatively cost-effective way. Due to the high velocity and the high temperature also normally a sufficiently good adhesion is reached.

However, if layers of a thickness of more than 100 μm must be applied, then usually considerable adhesion problems result, in particular, due to the differences between the coefficients of thermal expansion between the glass ceramic and the other layers. Thus for instance aluminum oxide layers which have the necessary breakdown resistance and thus a thickness in the range of several hundred micrometers, may be easily applied by thermal spraying, however usually fractures result, or the layers tend to chip off during operation, since due to the fast temperature cycling during operation considerable thermal stresses result.

The requirements with respect to the breakdown resistance can be reduced, if, as known from DE 31 05 065 C2 or from U.S. Pat. No. 6,037,572, between the insulating layer and the cooking plate an electrically conductive layer is applied that is grounded. In such a case a breakdown resistance of about 1,500 V is sufficient for the ceramic insulating layer, to guarantee the necessary operating safety according to VDE.

In this way the thickness of the ceramic insulating layer can be considerably reduced, whereby problems due to the differences between the thermal expansions are reduced.

On the other hand the utilization of a metallic intermediate layer according to DE 31 05 065 C2 or according to U.S. Pat. No. 6,037,572 has the disadvantage that an additional layer is introduced into the composite, which again has a coefficient of thermal expansion which is considerably higher than that of the cooking plate, whereby the stability of the overall system is influenced disadvantageously.

### SUMMARY OF THE INVENTION

Thus it is a first object of the invention to disclose a ceramic cooktop having an improved operating safety.

It is a second object of the invention to disclose a ceramic cooktop having a good long term stability in rough daily operation.

It is a third object of the invention to disclose a ceramic cooktop that is easy to produce in a cost-effective way.

It is a forth object of the invention to disclose a method of producing such a ceramic cooktop.

These and other objects are solved according to the invention by designing the intermediate layer as a thermally sprayed layer consisting of an electrically conductive ceramic or of a cermet.

The object of the invention is solved completely in this way.

By designing the intermediate layer as an electrically conductive ceramic a considerably improved matching of the coefficient of the thermal expansion of the intermediate layer to the coefficient of expansion of the cooking plate is reached, the latter being almost zero, since the coefficient of thermal expansion of suitable ceramic materials is considerably lower than the coefficient of expansion of metals. Also when utilizing a cermet layer a lower thermal expansion results due to the ceramic parts dispersed within the metallic matrix, whereby thermal stresses are reduced.

While a particularly good electrical conductivity can be reached, when utilizing a cermet layer, possibly when utilizing an electrically conductive ceramic a somewhat reduced electrical, conductivity must be accepted. However the utilization of an electrically conductive ceramic as an intermediate layer offers the additional advantage that the ceramic can be better matched to the glass ceramic of the cooking plate with respect to the material selection, wherein by means of a particular material selection a particularly good adhesion and low thermal stresses can be reached in operation.

According to a preferred development of the invention the intermediate layer is designed as an oxide layer which is electrically conductive by means of oxygen loss during thermal spraying.

Herein the intermediate layer may be made in particular of TiO₂, a mixture of Al₂O₃ with an addition of TiO₂ of at least 50 weight percent, preferably of at least 90 weight percent, of ZrO₂, of a mixture of Al₂O₃ with ZrO₂ with a portion of at least 50 weight percent, preferably of at least 90 weight percent, of a mixture of TiO₂ and ZrO₂, or of a mixture of Al₂O₃ with TiO₂ and ZrO₂ with a portion of at least 50 weight percent, preferably of at least 90 weight percent, of TiO₂ and ZrO₂.

These intermediate layers of TiO₂₋ₓ, ZrO₂₋ₓ, or of mixtures of Al₂O₃ with TiO₂₋ₓ and/or ZrO₂₋ₓ offer a particularly good adhesion to a glass ceramic surface. By thermal spraying the oxygen portion is reduced so far that this material becomes electrically conductive.

Thus for instance for TiO₂₋ₓ with x≦0.1 a volume conductivity of about 10³ Ohms×cm up to about 5×10² Ohms×cm results (at room temperature). Due to the relatively small thermal expansion of TiO₂₋ₓ, and due to the particularly good affinity of TiO₂₋ₓ, to the glass ceramic, in particular TiO₂₋ₓ appears suitable as an electrically conductive intermediate layer.

However, beyond that also the other mentioned materials can easily be utilized, wherein also other, chemically similar oxides appear suitable, that undergo a sufficiently high oxygen loss during thermal spraying, to reach a sufficiently good electrical conductivity.

As mentioned before, the intermediate layer may also be made of a cermet comprising a metal matrix. Herein the metal matrix preferably comprises at least one of the components nickel, cobalt and chromium.

According to an advantageous development of this embodiment the intermediate layer is made of a cermet having a metal matrix which is an alloy comprising the major components nickel, cobalt and chromium.

Herein also particles of carbide, such as tungsten carbide, chromium carbide or the like, may be dispersed within the metal matrix.

With such a cermet a good electrical conductivity of the intermediate layer is reached, wherein at the same time the coefficient of thermal expansion is considerably reduced when compared to a pure metal matrix, due to the ceramic inclusions. The respective metal matrix also offers a good adhesion to a glass ceramic surface and, due to the enhanced ductility, is suitable to absorb to a certain extent or to reduce thermal stresses, which may occur during operation.

According to an additional development of the invention between the electrically conductive intermediate layer and the cooking plate a ceramic bonding layer is provided.

This bonding layer preferably consists of aluminum oxide, of titanium oxide or of mixtures thereof and is, preferably, applied by thermal spraying.

In particular when utilizing a cermet material as an intermediate layer, the bonding layer leads to an additionally improved adhesion to the glass ceramic surface, whereby an extremely stable layer composite is reached having a very good temperature tolerance and temperature cycling tolerance.

The insulating layer which is applied to the intermediate layer may, for instance, consist of cordierite or of mullite, and is, preferably, applied by thermal spraying.

The utilization of these ceramics to produce the insulating layer offers the advantage of a relatively low coefficient of thermal expansion which is between about 4.3 and 5.0×10⁻⁶ K⁻¹ with respect to mullite, and is between about 2.2 and 2.4×10⁻⁶ K⁻¹ with respect to cordierite. Due to the low coefficients of thermal expansion only small tensions in combination with the cooking plate of a glass ceramic result.

Basically, naturally also other ceramic materials can be utilized for producing the ceramic insulating layer, such as Al₂O₃, however, with respect to the materials mentioned before particular advantages result from the lower coefficient of thermal expansion, while having a sufficiently high breakdown resistance at the same time.

It will be understood that the above-mentioned and following features of the invention are not limited to the given combinations, but are applicable in other combinations or taken alone without departing from the scope of the invention.

### BRIEF DESCRIPTION OF THE DRAWINGS

Further features and advantages of the invention will become apparent from the following description of preferred embodiments taken in conjunction with the drawings. In the drawings:

FIG. 1 shows a cross sectional view of a ceramic cooktop according to a first embodiment of the invention and

FIG. 2 shows a cross sectional view of a ceramic cooktop according to a second embodiment of the invention.

### DETAILED DESCRIPTION OF THE PREFERRED EMBODIMENTS

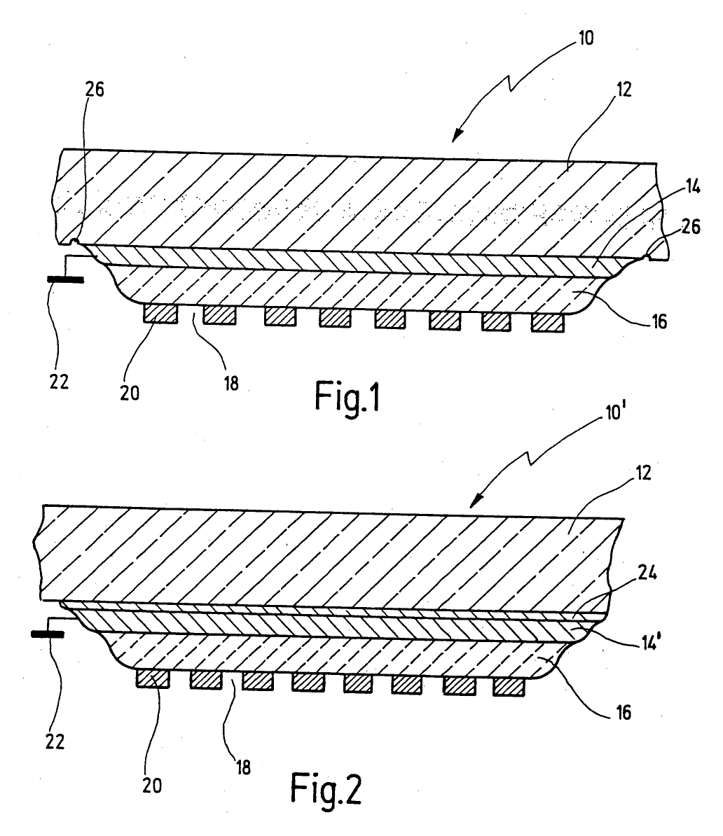

In FIG. 1 a ceramic cooktop according to the invention is shown in cross sectional view and designated in total with numeral 10.

It will be understood that the representation is merely of exemplary nature, and, in particular, the dimensional relations are not drawn to scale.

The ceramic cooktop comprises a cooking plate 12 of glass ceramic, such as of Ceran®. This cooking plate 12 serves to support cooking utensils. At the lower surface of the cooking plate 12 a cooking area has been produced at several areas. For household purposes herein typically four or possibly five cooking areas are provided on a ceramic cooktop. In FIGS. 1 and 2 only one cooking area is shown respectively. Onto the lower side of the cooking plate 12 an intermediate layer has been applied by thermal spraying. This may for instance be effected by atmospheric plasma spraying (APS) with a layer thickness of 50 to 250 μm. The application of the respective layers is preferably only performed at the respective cooking areas, to keep the overall stresses as low as possible.

Before thermal spraying the glass ceramic is cleaned, for instance degreased utilizing acetone. The pretreatment by sandblasting which is commonly performed in prior art spraying operations, is not performed in this case, since this would lead to a damage of the glass ceramic.

After producing the intermediate layer 14 an insulating layer 16 which, preferably, consists of cordierite (2MgO.2Al₂O_{3.}5SiO₂) or of mullite (3Al₂O_{3.}2SiO₂), is applied again by atmospheric plasma spraying.

The thickness of the insulating layer 16 depends on the desired breakdown resistance and on the utilized material and is between about 100 and 500 μm, preferably between about 150 and 300 μm.

Thereafter, onto the insulating layer a heat conductor layer 18 is applied which may take the form of a meander shaped heat conductor 20. The heat conductor 20 may be applied by a screen printing process known in the art, wherein by applying a glassy portion of normally more than 5% the flow temperatures during layer firing can be reduced such that firing temperatures between about 500 and 850° C. result, this leading to a dense, close conductor layer.

Alternatively, the heat conductor layer 18 may also be prepared by thermal spraying. To this end initially the portion not to be coated is masked by utilizing a masking process known in the art, thereafter the exposed portions are coated with the heat conductor material by thermal spraying.

The portion masked before can be removed thereafter, so that a wound heat conductor 20 results, the individual heat conductor track of which are insulated from each other.

The intermediate layer 14 which is applied by thermal spraying of TiO₂ becomes electrically conductive due to the high oxygen loss of the titanium oxide during thermal spraying. Herein a volume conductivity of about 10³ Ohms×cm up to about 5×10² Ohms×cm results (at room temperature). This is sufficient to effectively ground the intermediate layer 14, as indicated in FIG. 1 by the connection to ground 22. Thereby the necessary breakdown resistance of the insulating layer 16 is reduced to about 1,500 V. In case of defect by breakdown of heat conductor 20 to the cooking plate 12 a safety switch, generally known in the art but not shown here, is triggered.

A modification of the ceramic cooktop is depicted in FIG. 2 and designated in total with the numeral 10′.

Again onto the lower side of the cooking plate 12 consisting of glass ceramic, such as Ceran®, an electrically conductive intermediate layer 14′ is applied. However, this intermediate layer 14′, which is a cermet layer, is separated by a bonding layer 24 sprayed onto the cooking plate 12.

The bonding layer 24 preferably consists of Al₂O₃ or of a mixture of Al₂O₃ and TiO₂, e.g. 97 weight percent Al₂O₃ and 3 weight percent TiO₂. The bonding layer 24 is thermally sprayed with a layer thickness of about 10 to 150 μm, preferably by atmospheric plasma spraying. The preferred layer thickness is in the range of about 30 to 100 μm. Thereafter, onto the bonding layer 24 a cermet layer consisting of a nickel/cobalt/chromium alloy comprising dispersed carbide particles (tungsten carbide, chromium carbide etc.) is sprayed. The intermediate layer 14′ is produced with a layer thickness of about 50 to 250 μm, preferably of about 50 to 100 μm. Thereafter, the insulating layer 16 and the heat conductor layer 18 are applied thereon, as previously described with respect to FIG. 1.

As can be seen from FIGS. 1 and 2, the individual layers lying above each other each taper radially at the rim region and thus verge respectively into the respective layer lying there under. Also the total area of the individual layers diminishes into the direction of the heat conductor layer. Also in this way advantageous stress characteristics in the rim areas of the respective layers are reached, this counteracting a delamination of the respective layers.

In addition, in FIG. 1 an annular recess 26 is shown surrounding the intermediate layer 14 at the rim region thereof in an annular way.

Due to this small recess stresses which may emerge between the cooking plate 12 and the intermediate layer 14 are absorbed and reduced to a certain extent.

What is claimed is:

1. A ceramic cooktop comprising:
a cooking plate made of a material selected from the group formed by a glass ceramic and a glass;
a thermally sprayed electrically conducting intermediate layer located on said ceramic bonding layer and being connected to ground;
a thermally sprayed insulating layer located on said intermediate layer; and
a thermally sprayed electric heat conductor layer located on said insulating layer;
wherein said intermediate layer is configured as an oxide layer that is rendered electrically conductive by oxygen loss during thermal spraying.

2. The ceramic cooktop of claim 1, wherein said intermediate layer is made of a material selected from the group formed by TiO₂, a mixture of Al₂O₃ having a portion of at least 50 wt.-% of TiO₂, ZrO₂, a mixture of Al₂O₃ with ZrO₂ having a portion of at least 50 wt.-% of ZrO₂, and a mixture of Al₂O₃ with TiO₂ and ZrO₂ having a portion of at least 50 wt.-% of TiO₂ and ZrO₂.

3. The ceramic cooktop of claim 1, wherein said insulating layer consists of a material selected from the group formed by cordierite and mullite.

4. A ceramic cooktop comprising:
a cooking plate made of a material selected from the group formed by a glass ceramic and a glass;
a thermally sprayed electric heat conductor layer;
a thermally sprayed insulating layer arranged between said cooking plate and said heat conductor layer; and
an electrically conducting intermediate layer arranged between said cooking plate and said insulating layer;
wherein said intermediate layer is configured as a thermally sprayed layer consisting of cermet material.

5. The ceramic cooktop of claim 4, wherein said cermet material has a metal matrix comprising at least one component selected from the group formed by nickel, cobalt and chromium.

6. The ceramic cooktop of claim 4, wherein said cermet material has a metal matrix being configured as an alloy comprising the major components nickel, cobalt and chromium.

7. The ceramic cooktop of claim 4, wherein said cermet material further comprises carbide particles dispersed within said metal matrix.

8. The ceramic cooktop of claim 7, wherein said carbide particles are selected from the group formed by tungsten carbide and chromium carbide.

9. The ceramic cooktop of claim 4, wherein said insulating layer consists of a material selected from the group formed by cordierite and mullite.

10. The ceramic cooktop of claim 9, wherein said insulating layer is a thermally sprayed layer.

11. A ceramic cooktop comprising:
a cooking plate made of a material selected from the group formed by a glass ceramic and a glass;
an electric heat conductor layer;
an insulating layer arranged between said cooking plate and said heat conductor layer; and
an electrically conducting intermediate layer located between said cooking plate and said insulating layer;
wherein said intermediate layer is configured as a thermally sprayed layer consisting of an electrically conductive material selected from the group formed by a ceramic and a cermet.

12. The ceramic cooktop of claim 11, wherein said intermediate layer is configured as an oxide layer that is rendered electrically conductive by oxygen loss during thermal spraying.

13. The ceramic cooktop of claim 12, wherein said intermediate layer consists of a cermet material having a metal matrix comprising at least one component selected from the group formed by nickel, cobalt and chromium.

14. The ceramic cooktop of claim 13, wherein said cermet material has a metal matrix being configured as an alloy comprising the major components nickel, cobalt and chromium.

15. The ceramic cooktop of claim 14, wherein said intermediate layer consists of a cermet material having a metal matrix comprising carbide particles dispersed within said metal matrix.

16. The ceramic cooktop of claim 15, wherein said carbide particles are selected from the group formed by tungsten carbide and chromium carbide.

17. The ceramic cooktop of claim 14, wherein said insulating layer consists of a material selected from the group formed by cordierite and mullite.

18. The ceramic cooktop of claim 17, wherein said insulating layer is a thermally sprayed layer.
